(19) United States
(12) Patent Application Publication
(10) Pub. No.: US 2020/0362556 A1
(43) Pub. Date: Nov. 19, 2020

(54) RADIOPROTECTIVE BUILDING BLOCK FOR BUILDING A WALL THAT IS ABLE TO FORM A SCREEN TO IONIZING RADIATION

(71) Applicant: LEMER PAX, LA CHAPELLE SUR ERDRE (FR)

(72) Inventor: Pierre-Marie LEMER, NANTES (FR)

(21) Appl. No.: 16/956,389

(22) PCT Filed: Dec. 14, 2018
(86) PCT No.: PCT/FR2018/053309

§ 371 Date: Jun. 19, 2020

(30) Foreign Application Priority Data
Dec. 19, 2017 (FR) 1762546

(51) Int. Cl. E04B 1/92; E04B 2/12; E04B 2/08; E04C 1/40; E04C 1/39; G21F 3/04; G21F 7/00

(52) U.S. Cl. CPC E04B 1/92; E04B 2/12; E04B 2/08; E04B 2002/021; E04C 1/39; G21F 3/04; G21F 7/00; E04C 1/40

(57) ABSTRACT

Disclosed is a radioprotective building block for building a wall that is able to form a screen to ionizing radiation. The radioprotective building block includes:—a core made of at least one radioprotective material, and—a shell enclosing said core and including at least one shell part that is fitted around the core.

### TECHNICAL FIELD TO WHICH THE INVENTION RELATES

The present invention generally relates to the field of equipment for protection against ionizing radiation.

It more particularly relates to a radioprotective building block suitable for building a wall that is able to form a screen against ionizing radiation.

### TECHNOLOGICAL BACK-GROUND

Lead is an excellent shielding material against ionizing radiation (for example, X and gamma rays), thanks to its density, high atomic number and stability level.

This radioprotective material is in addition interesting for its easy machinability.

In certain applications, this material can hence be in the form of building blocks or “bricks”, for example chevron-patterned or parallelepipedal.

Such building blocks have for interest that they are of very flexible and versatile use, for example to build very rapidly a wall that is able to form a screen against ionizing radiation emitted during the handling or the storage of radioactive sources.

Such a modulable and removable wall is made by juxtaposing, placing side by side and/or stacking the radioprotective building blocks.

But these lead-based radioprotective building blocks are usually little accomplished and little environmentally friendly.

Considering the toxicity of lead, the handling of these building blocks is problematic.

Finally, in case of contamination, the decontamination of these building blocks is difficult and expensive.

### OBJECT OF THE INVENTION

In order to remedy the above-mentioned drawback of the state of the art, the present invention proposes a radioprotective building block for building a wall that is able to form a screen against ionizing radiation.

This building block comprises:
a core, made of at least one radioprotective material, and
a shell, enclosing said core, comprising at least one shell part that is fitted around said core.

Such a building block has for interest to be more environmentally friendly and to be handleable without particular constraints.

It is possible to choose the colour of the shell, for example as a function of its use or its area, for example.

In case of contamination, the decontamination of these building blocks is simplified: the shell can be removed from the core to be replaced by a new “clean” shell; the “contaminated” shell can be integrated into an existing treatment system, for a low cost.

Other non-limitative and advantageous characteristics of the building block according to the invention, taken individually or according to all the technically possible combinations, are the following:
said at least one shell part is made of a plastic material and/or a metallic material (for example, steel);
said at least one shell part is made of a non-radioprotective material;
said core is made of lead or a lead alloy, or even of steel;
said at least one shell part is held around said core using fastening means, potentially removable fastening means; preferably, this shell is consisted of at least two shell parts, and the fastening means comprise interlocking means between said shell parts;
said at least one shell part is made of a heat-shrinkable film;
the radioprotective building block consists of a brick, a slab, a lintel;
the building block consists of a parallelepipedal brick, a chevron-patterned brick, or a portion of cylindrical shell;
the core has an external surface, and said at least one shell part comprises an internal surface that conforms at least a part of said external surface of the core.

The invention also proposes a shell for a radioprotective building block according to the invention, wherein said shell, adapted to enclose the core, is consisted of at least one shell part capable of being held around said core using fastening means (advantageously removable).

### DETAILED DESCRIPTION OF AN EXEMPLARY EMBODIMENT

The following description in relation with the appended drawings, given by way of non-limitative example, will allow a good understanding of what the invention consists of and of how it can be implemented.

In the appended drawings:

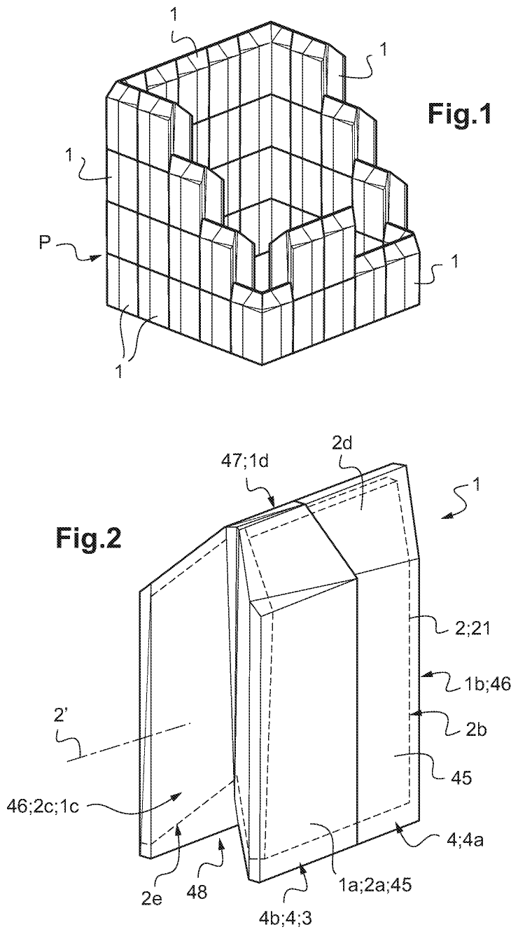

FIG. 1 is a general and perspective view of a wall built by assembly of a plurality of radioprotective building blocks according to the invention;

FIG. 2 shows, in an isolated and perspective view, a radioprotective building block according to the invention that is suitable for building a wall according to FIG. 1 (the core is schematically shown in dashed line);

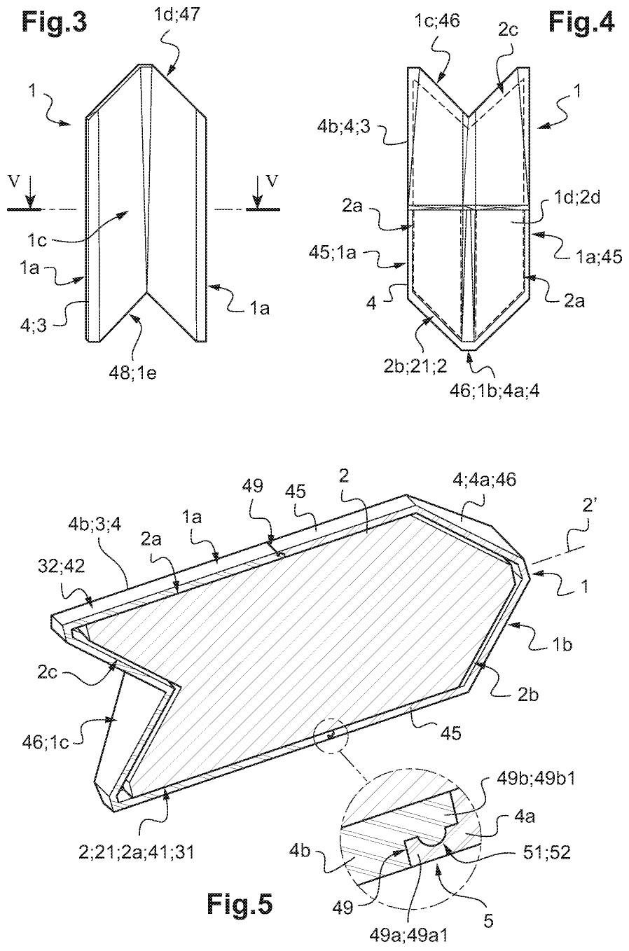

FIGS. 3 and 4 show, in a face and a top view, respectively, the radioprotective building block according to FIG. 2 (the core is schematically shown in dashed line in FIG. 4);

FIG. 5 is a cross-sectional view of the radioprotective building block of FIGS. 2 to 4, according to a sectional plane V-V of FIG. 3, with a partial and enlarged view of the interlocking means arranged between two shell parts.

FIG. 1 shows a wall P (advantageously vertical) that is built by assembly of a plurality of radioprotective building blocks 1 according to the invention.

Such a wall P is modulable and removable. It is advantageously made by juxtaposing, placing side by side and/or stacking the radioprotective building blocks 1.

In practice, this wall P is intended to form a screen against ionizing radiation emitted by a radioactive source during the handling and/or the storage thereof.

Radioprotective Building Block

A radioprotective building block 1 according to the invention is described in detail hereinafter in relation with FIGS. 2 to 5.

The radioprotective building block 1 (also called “block” or “building block”) comprises:
a core 2, made of at least one radioprotective material, and
a shell 3 comprising at least one shell part 4 that is fitted around said core 2, said shell 3 enclosing said core 2 and forming the external surface of this radioprotective building block 1.

The radioprotective building block 1 has here an external shape of the chevron-patterned brick type.

This radioprotective building block 1 hence comprises a set of external faces 1a to 1e, i.e.:
two planar lateral faces 1a, parallel to each other and intended to extend vertically;
a convex, V-shaped front face 1b, intended to extend vertically,
a concave, V-shaped rear face 1c, intended to extend vertically and complementary of said convex front face 1b,
a convex, V-shaped upper face 1d, intended to extend horizontally, and
a concave, V-shaped lower face 1e, intended to extend horizontally and complementary of said convex upper face 1d.

By “V-shaped”, it is advantageously meant a generally dihedral shape that is formed of two panels connected by a ridge.

As an alternative, not shown, the radioprotective building block 1 can have any other shape, for example a parallelepipedal shape or the shape of a portion of cylindrical shell (for example, a cylindrical half-shell).

Still generally, the radioprotective building block 1 according to the invention can consist of a brick, a slab (advantageously for the ground), a lintel (advantageously to form the top of an opening formed in a wall).

Core of the Radioprotective Building Block

The core 2 is advantageously made of lead or a lead alloy, advantageously forming a solid single-piece part. As an alternative, this core 2 could also be made of steel.

The core 2 has an external surface 21 that extends, at least approximately, parallel to the external faces 1a to 1e of the radioprotective building block 1.

This external surface 21 has thus a shape that is function of the arrangement of the external faces 1a to 1e of the radioprotective building block 1.

Herein, this external surface 21 has a profile of the chevon type, that is composed of the following faces:
two planar lateral faces 2a, parallel to each other,
a convex, V-shaped front face 2b,
a concave, V-shaped rear face 2c, complementary of the convex front face 2b,
a convex, V-shaped upper face 2d, and
a concave, V-shaped lower face 2e, complementary of said convex upper face 2d.

The core 2 also defines a horizontal longitudinal axis 2′, which extends parallel to the planar lateral faces 2a and to the couple convex upper face 2d/concave lower face 2e.

Shell and Shell Part(s)

The shell 3, enclosing the core 2, comprises two opposite surfaces:
an internal surface 31 that conforms at least a part of the external surface 21 of the core 2, and
an external surface 32 that forms the external faces 1a to 1e of the radioprotective building block 1.

This shell 3 is formed by at least one shell part 4.

Said at least one shell part 4 is advantageously made of a plastic material and/or a metallic material.

Moreover, said at least one shell part 4 is potentially made of a non-radioprotective material.

Among the plastic materials, it is advantageously meant the rigid or semi-rigid plastic materials, i.e. for example polyvinyl chloride (PVC), polyethylene, ABS, polyamide.

Among the metallic materials, it is advantageously meant steel.

Said at least one shell part 4 comprises two opposite surfaces:
an internal surface 41 that conforms at least a part of the external surface 21 of the core 2, and
an external surface 42 that forms at least a part of the external faces 1a to 1e of the radioprotective building block 1.

The two surfaces 41, 42 of a shell part 4 here extend parallel, or at least approximately parallel, to each other.

These two surfaces 41, 42 define the thickness of the shell part 4. This thickness is for example comprised between 0.1 and 3 mm.

Shell Part with Interlocking Means

In the embodiment shown in FIGS. 2 to 5, said at least one shell part 4 is held around the core 2 using fastening means 5.

The shell 3 comprises two shell parts 4 that are complementary of each other, here:
a first shell part 4a, called “front part”, on the side of and covering the convex front face 2b of the core 2, and
a second shell part 4b, called “rear part”, on the side of and covering the concave rear face 2c of the shell 2.

The shell parts 4 are shaped so as to cover the whole external surface 21 of the shell 2.

These two shell parts 4 are moreover similar to each other.

Within this framework:
the internal surface 41 of each shell part 4 conforms a part of the external surface 21 of the core 2, and
the external surface 42 of this same shell part 4 forms a part of the external faces 1a to 1e of the radioprotective building block 1.

Herein, each shell part 4 comprises several walls:
two planar and parallel lateral walls 45, covering a part of the two planar lateral faces 2a of the core 2,
a dihedral end wall 46, covering according to the case the convex front face 2b of the core 2 or the concave rear face 2c of the core 2,
a dihedral convex upper wall 47, covering a part of the convex upper face 2d of the core 2, and
a dihedral concave lower wall 48, covering a part of the concave lower face 2e of the core 2.

The “front” shell part 4a has an end wall 46 that is dihedral convex to cover the convex front face 2b of the core 2; and the “rear” shell part 4b has an end wall 46 that is dihedral concave to cover the concave rear face 2c of the core 2

Each shell part 4 is here also delimited by a free edge 49, corresponding to the edge of the lateral walls 45, of the upper wall 47 and of the lower wall 48.

The two free edges 49 are here intended to extend perpendicular to the longitudinal axis 2′ of the core 2, to the planar lateral faces 2a of the core 2 and to the lateral walls 45 of the shell parts 4.

These two free edges 49 are here located at the middle, or at least approximately at the middle, of the length of the planar lateral faces 2a of the core 2, so that each shell part 4 advantageously each forms a half-shell.

In other words, at each shell part 4:
each lateral wall 45 covers half of one of the two planar lateral faces 2a of the core 2,
the upper wall 47 covers half of the convex upper face 2d of the core 2, and
the lower wall 48 covers half of the concave lower face 2e of the core 2.

The fastening means 5 ensure the assembly and the holding of the two shell parts 4 around the core 2.

Such fastening means 5 are advantageously chosen among one at least of the following fastening means:
means for bonding the shell parts 4 to each other and/or to the core 2,
means for interlocking the shell parts 4 with each other and/or with the core 2,
mechanical fastening means, chosen for example among screwing means and/or riveting means, and
means for thermally welding the shell parts 4 to each other.

Herein, the fastening means 5 comprise interlocking means arranged at the above-mentioned free edges 49.

More precisely, the free edge 49 of one of the shell parts 4 cooperate by interlocking with the free edge 49 of the other shell part 4.

For that purpose, the free edge 49a of a shell part 4 (herein, the front shell part 4a) comprises a dihedral internal projection 49a1 (illustrated in detail in FIG. 5).

By “internal projection”, it is meant a projection formed at the internal surface 41 of the shell part 4.

The free edge 49b of the other shell part 4 (herein, the rear shell part 4b) comprises a dihedral external projection 49b1 (illustrated in detail in FIG. 5), which is complementary of the above-mentioned internal projection 49a1.

By “external projection”, it is meant a projection formed at the external surface 42 of the shell part 4.

Each projection 49a1, 49b1 advantageously extends over half of the thickness of the associated shell part 4.

These projections 49a1, 49b1 also comprise complementary interlocking structures 51, 52, here a groove/rib combination.

Herein, the dihedral internal projection 49a1 comprises a groove 51 and the dihedral external projection 49a1 comprises a rib 52.

Moreover, the bonding means consist for example of a glue added between the internal surface of the shell parts 4 and the external surface 21 of the core 2; complementary or as an alternative, this glue can be applied at the associated free edges 49.

This glue is for example chosen among plastic material solvents, cyanoacrylates, epoxides, neoprenes, etc.

The thermal welding means consist for example in making a thermal welding at the associated free edges 49 to form a welding line.

This thermal welding is for example made by means of a high-frequency welding or heating blades.

It may also be contemplated to combine several types of fastening means, for example an interlocking of the two shell parts 4 associated with a bonding or a high-frequency welding at the interlocking lines.

Generally, the fastening means 5 consist of removable fastening means (this is the case in particular of the interlocking means) so as to allow the separation between the core 2 and said at least one shell part 4.

Said at least one shell part 4, dissociated from the core 2, can then be integrated into a waste treatment system.

Thermo-Shrinkable Film

As an alternative, not shown, said at least one shell part 4 consists of a thermo-shrinkable film.

Said at least one shell part 4 is held around the core 2 by conforming the external surface 21 thereof.

Manufacturing Method

The manufacturing of a radioprotective building block 1 according to the invention advantageously comprises the following steps:
a step of providing the core 2 and said at least one shell part 4, then
a step of fastening said at least one shell part 4 around the core 2.

In the embodiment according to FIGS. 2 to 5, the step of providing said at least one shell part 4 advantageously comprises a step of manufacturing these shell parts 4 by compression, thermoforming or also, preferably, injection moulding.

The fastening step consists, according to the case, in one at least of the above-mentioned fastening steps: bonding, interlocking, thermal welding.

In the case of a thermo-shrinkable film, said at least one shell part 4 is positioned so that its internal surface 41 covers at least a part of the core 2.

This shell part 4 is then subjected to a heat treatment so that its internal surface 41 shrinks and conforms the external surface 21 of the core 2.

Modulable and Removable Wall

A plurality of radioprotective building block 1 is assembled to form the modulable and removable wall P.

This wall P is advantageously made by juxtaposing, placing side by side and/or stacking the radioprotective building blocks 1.

In the case of the chevron-patterned radioprotective building blocks 1 described in relation with FIGS. 2 to 5, their complementary faces interlock into each other by pairs:
the convex front face 1b of a block 1 interlocks into the concave rear face 1c of another juxtaposed block 1, and
the convex upper face 1d of a block 1 interlocks into the concave lower face 1e of at least another overlying block 1.

Due to the shape of the chevron-patterned core 2, the cores 2 of adjacent blocks 1 also interlock into each other by pairs:
the convex front face 2b of a block 1 interlocks into the concave rear face 2c of a juxtaposed block 1, and
the convex upper face 2d of a block 1 interlocks into the concave lower face 2e of at least one overlying block 1.

The cores 2 of the assembled blocks 1, hence forming a wall P, hence form together a continuous screen against ionizing radiation.

1. A radioprotective building block for building a wall that is able to form a screen against ionizing radiation,
wherein said radioprotective building block (1) comprises:
a core (2), made of at least one radioprotective material, and
a shell (3), enclosing said core (2), comprising at least one shell part (4) that is fitted around said core (2).

2. The radioprotective building block according to claim 1, wherein said at least one shell part (4) is made of a plastic material and/or a metallic material.

3. The radioprotective building block according to claim 2, wherein said at least one shell part (4) is made of a non-radioprotective material.

4. The radioprotective building block according to claim 2, wherein said core (2) is made of lead or a lead alloy.

5. The radioprotective building block according to claim 2, wherein said at least one shell part (4) is held around said core (2) using fastening means (5).

6. The radioprotective building block according to claim 5, wherein the shell (3) is consisted of at least two shell parts (4),
and wherein the fastening means (5) comprise interlocking means (51, 52) between said shell parts (4).

7. The radioprotective building block according to claim 1, wherein said at least one shell part (4) is made of a thermo-shrinkable film.

8. The radioprotective building block according to claim 1, wherein it consists of a brick, a slab, a lintel.

9. The radioprotective building block according to claim 1, wherein it consists of a parallelepipedal brick, a chevron-patterned brick, or a portion of cylindrical shell.

10. The radioprotective building block according to claim 2, wherein the core (2) has an external surface (21), and in that said at least one shell part (4) comprises an internal surface (41) that conforms at least a part of said external surface (21) of the core (2).

11. A shell for a radioprotective building block (1) according to any claim 1, wherein said shell (3), adapted to enclose the core (2), is consisted of at least one shell part (4) capable of being held around said core (2) using fastening means (5).

12. The radioprotective building block according to claim 6, wherein said core (2) is made of lead or a lead alloy.

13. The radioprotective building block according to claim 6, wherein it consists of a parallelepipedal brick, a chevron-patterned brick, or a portion of cylindrical shell.

14. The radioprotective building block according to claim 13, wherein said core (2) is made of lead or a lead alloy.

15. A shell for a radioprotective building block (1) according to any claim 2, wherein said shell (3), adapted to enclose the core (2), is consisted of at least one shell part (4) capable of being held around said core (2) using fastening means (5).

16. A shell for a radioprotective building block (1) according to any claim 3, wherein said shell (3), adapted to enclose the core (2), is consisted of at least one shell part (4) capable of being held around said core (2) using fastening means (5).

17. A shell for a radioprotective building block (1) according to any claim 4, wherein said shell (3), adapted to enclose the core (2), is consisted of at least one shell part (4) capable of being held around said core (2) using fastening means (5).

18. A shell for a radioprotective building block (1) according to any claim 5, wherein said shell (3), adapted to enclose the core (2), is consisted of at least one shell part (4) capable of being held around said core (2) using fastening means (5).

19. A shell for a radioprotective building block (1) according to any claim 6, wherein said shell (3), adapted to enclose the core (2), is consisted of at least one shell part (4) capable of being held around said core (2) using fastening means (5).

20. A shell for a radioprotective building block (1) according to any claim 7, wherein said shell (3), adapted to enclose the core (2), is consisted of at least one shell part (4) capable of being held around said core (2) using fastening means (5).
